(19) United States
(12) Patent Application Publication
(10) Pub. No.: US 2010/0222638 A1
(43) Pub. Date: Sep. 2, 2010

(54) WARMING THERAPY DEVICE INCLUDING HOOD WITH FACETED SHAPE

(75) Inventor: Robert J. Chilton, III, Quakertown, PA (US)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: DRAEGER MEDICAL SYSTEMS, INC., Telford, PA (US)

(21) Appl. No.: 12/738,511

(22) PCT Filed: Dec. 2, 2008
(86) PCT No.: PCT/US08/85247

§ 371 Date: Apr. 16, 2010

Related U.S. Application Data
(60) Provisional application No. 61/005,360, filed on Dec. 4, 2007.

(51) Int. Cl. A61G 11/00

(52) U.S. Cl. 600/22

(57) ABSTRACT

An apparatus and method for providing patient access in a warming therapy device (e.g. j incubator, warmer, etc.) is described. In one exemplary embodiment, the apparatus includes a patient support assembly and a hood with one or more facets which permit easy viewing of an infant patient disposed on the patient support assembly.

### CROSS-REFERENCE TO RELATED APPLICATIONS

This application claims the benefit of U.S. Provisional Patent Application No. 61/005,360, filed on Dec. 4, 2007, the entire contents of which is incorporated herein by reference, as if fully set forth herein.

### FIELD OF THE INVENTION

The present invention relates generally to a method and apparatus for providing patient access in a warming therapy device (e.g. incubator, warmer, etc.). More particularly, the present invention relates to a method and apparatus for providing viewing access to an infant patient through a faceted hood.

### BACKGROUND

Warming therapy devices often have hoods, which enclose a patient on a mattress of the warming therapy device. The enclosure provided by the hood creates a closed care environment in which environmental conditions such as temperature, humidity, etc., can be control led. Normally, a heater provides a warm temperature that is beneficial to an infant patient in the closed care environment. The hood assists in maintaining the warm temperature as well, at a desired humidity level.

Because the closed care environments of warming therapy devices often contain infant patients, there is a need to easily see into the closed care environment with very little or no distortion. There is often a need for visual assessment of infants within warming therapy devices. Visual assessment may include checking the infant for heartbeat, breathing patterns, skin hue etc. In addition, it is often necessary to take diagnostic images such as x-rays, radiography, etc., of the infant patient. Many conventional warming therapy device hoods are constructed with a rounded shape, which may distort, obscure and/or obstructs at least some of the view into the closed care environment. These hoods may also distort the diagnostic images. This is often due to the refraction and reflection of light. In addition, some conventional hoods are often larger than necessary resulting in an excess use of energy to maintain the desired environmental conditions.

It would be beneficial to have a warming therapy device with a hood that permits easy viewing of the infant patient inside and that allows for more accurate diagnostic images and visual assessment. It would further be desirable to provide a hood that was adapted to receive radiant heat, such as from raised radiant heaters for purposes of condensation control, and minimize hot spots to evenly distribute the radiant heat across the hood. Accordingly, there is a need for a warming therapy device with a hood that allows for easy viewing of an infant patient, and also allows efficient temperature and condensation control of the infant patient environment.

### SUMMARY

An exemplary embodiment of the present invention may be an apparatus comprising a patient support surface and a hood adapted to cover a portion of the patient support surface, wherein the hood is comprised of at least one sidewall and at least one top portion and wherein the at least one top portion has a plurality of facets.

An exemplary embodiment of the present invention also may be a hood for a warming therapy device adapted to cover a portion of a patient support surface, the hood comprising at least one sidewall and at least one top portion, wherein the at least one top portion has a plurality of facets.

An exemplary embodiment of the present invention also may be a warming therapy device comprising a patient support assembly having a patient support surface and a hood coupled to the patient support assembly, the hood adapted to cover a portion of the patient support surface, wherein the hood is comprised of at least one sidewall and at least one top portion, and wherein the at least one top portion has a plurality of facets.

### BRIEF DESCRIPTION OF THE DRAWINGS

FIG. 1 is perspective view of a warming therapy device according to a first exemplary embodiment of the present invention.

FIG. 2A is a front side plan view of the patient support surface and hood shown in FIG. 1.

FIG. 2B is a right side plan view of the patient support surface and hood shown in FIG. 1.

FIG. 3 is a top plan view of the hood shown in FIG. 1.

FIG. 4 is a left side plan view of the hood shown in FIG. 1, where the hood is an open position.

FIG. 5A is a perspective view of a hood and patient support surface according to a second exemplary embodiment of the present invention.

FIG. 5B is a front side plan view of the patient support surface and hood shown in FIG. 5A.

FIG. 5C is a right side plan view of the patient support surface and hood shown in FIG. 5A.

FIG. 5D is a top plan view of the patient support surface and hood shown in FIG. 5A.

FIG. 5E is a side plan view of the patient surface and hood shown in FIG. 5A in the open position.

FIG. 6A is perspective view of a warming therapy device according to a second exemplary embodiment of the present invention, and a hood and patient support surface according to a third exemplary embodiment of the present invention.

FIG. 6B is a top plan view of the hood shown in FIG. 6A.

FIG. 6C is a front side plan view of the hood shown in FIG. 6B.

FIG. 6D is a right side plan view of the hood shown in FIG. 6B.

FIG. 7 is a perspective view of the warming therapy device shown in FIG. 6A in an open position with a mattress tray rotated ninety degrees.

### DETAILED DESCRIPTION

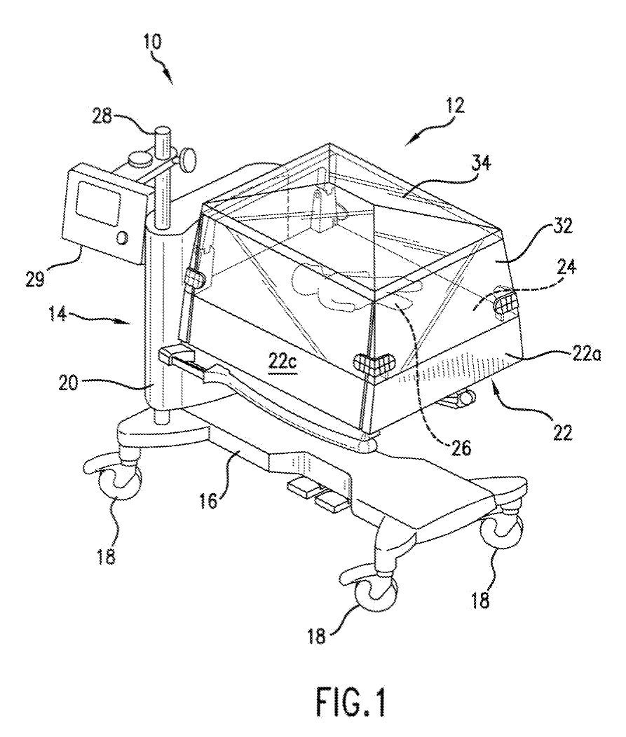

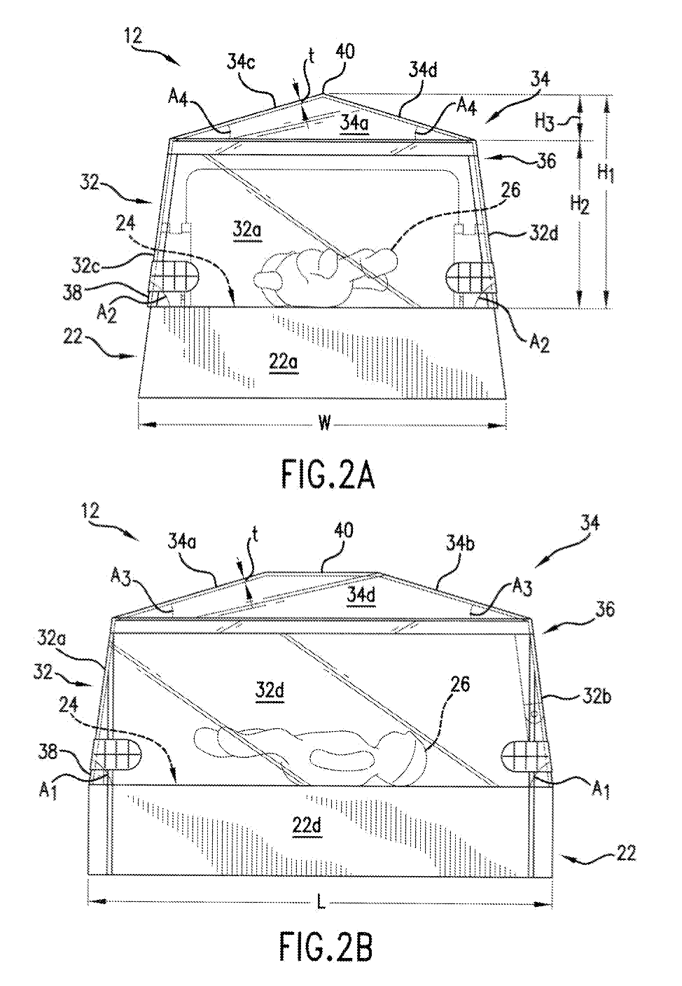

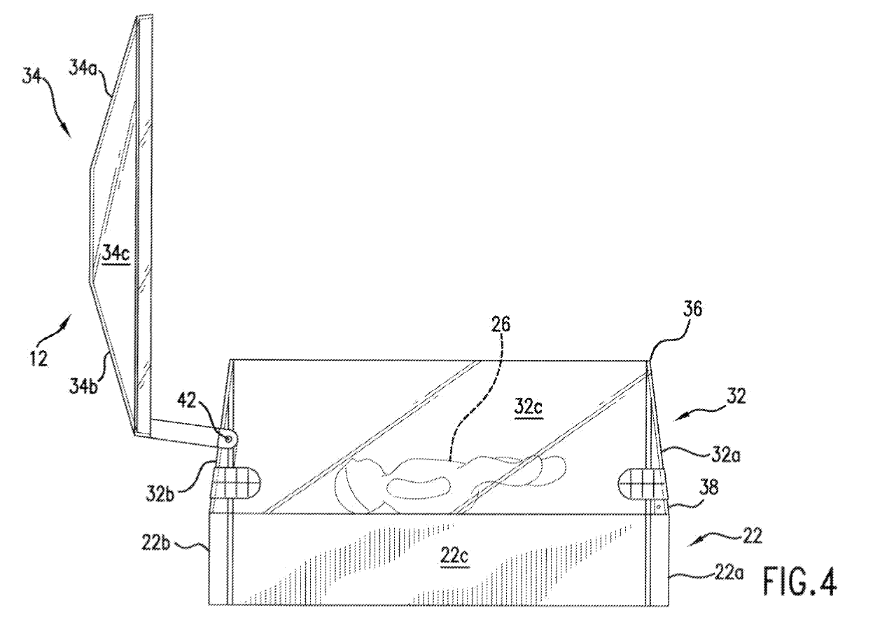

FIG. 1 shows a warming therapy device 10 according to a first exemplary embodiment of the present invention. The warming therapy device 10 may include a hood 12 (the details of which are shown in FIGS. 2A and 2B), and a patient support assembly 14. The patient support assembly 14 includes a base 16 with wheels 18. The patient support assembly 14 may also include an adjustable-height support member 20 which is coupled to the base 16 at one end. The support member 20 may be, in turn, coupled to a patient support surface 22, for supporting an infant patient 26. The patient support surface 22 may further comprise a mattress (not shown) also for supporting the infant patient 26. The patient support surface 22 may comprise a generally rectangular or trapezoidal platform generally sized for the infant patient 26, however, those of ordinary skill in the art will realize that the patient support surface 22 may be of any suitable size and shape. The patient support surface 22 has a front side 22a and an opposing rear side 22b (shown in FIG. 4), as well as a left side 22c, and an opposing right side 22d (shown in FIG. 2B).

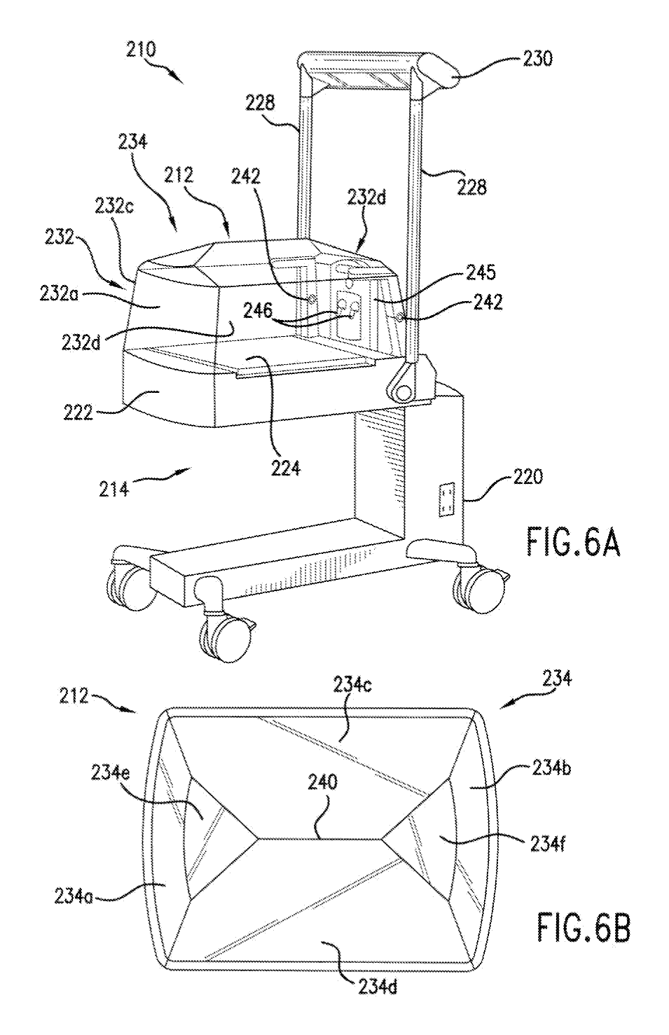

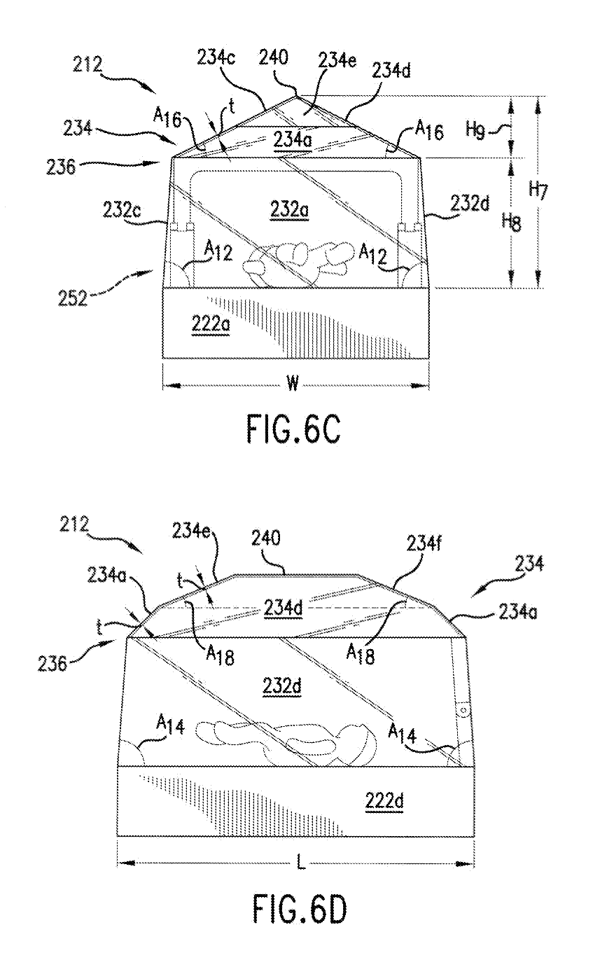

The warming therapy device 10 may also include at least one support arm 28. The support arm 28 may be coupled to the patient support surface 22 so as to allow the support arm to rotate about the patient support surface. Additionally, the support arm 28 may be made retractable or collapsible so that it fits partially or entirely within the support member 20 when not extended. The support arm 28 may also support the attachment of various medical devices thereto, such as intravenous (IV) pumps, patient monitors, or the like. One or more radiant heaters (not shown) may also be coupled to the support arm 28 to provide heating of the hood 12 to reduce condensation on the hood 12. Alternatively, if the hood is constructed of an infrared transparent material, the radiant heat may also be used to heat the patient enclosure. FIG. 6A, for example, shows a warming therapy device 210 according to a second exemplary embodiment of the present invention which includes a heater 230 which overlies a patient support surface 222. The heater 230 may be positioned so that the heater head (or heat source) is about 400 mm to about 1300 mm from the mattress or patient support surface 22. Preferably, the heater is angled so that it intersects a side facet (described below) at an optimal angle for reducing or substantially eliminating condensation on the hood. As such, the heater may be disposed over a portion of the patient support surface and hood. Referring again to FIG. 1, the patient support assembly 14 may also include a control panel 29 disposed on the support arm 28 for controlling various functions of the warming therapy device 10.

The hood 12 may be comprised of one or more sidewalls 32, and a top portion 34. In the exemplary embodiment, the hood 12 includes four (4) sidewalls 32a, 32b, 32c, 32d, corresponding to the front, rear, right and left sides respectively (See FIGS. 2A and 2B). The top portion 34 and sidewalls 32a-32d of the hood 12 may be comprised of a substantially optically transparent material such as a clear polymer such as acrylic and/or some infrared transparent material. However, those of ordinary skill in the art will understand that the top portion 34 and sidewalls 32a-32d of the hood 12 may be made of other materials as long as they allow viewing of an infant patient disposed on the patient support surface 22, and maintain the desired environmental conditions (i.e., temperature levels). Although the sidewalls 32a-32d are shown as substantially rectangular in FIG. 1, those of ordinary skill in the art will realize that the sidewalls may be of any suitable shape, such as square, trapezoidal, rounded, etc. Additionally, although these sidewalls 32a-32d are shown as substantially flat along their surface in FIG. 1, those of ordinary skill in the art will realize that they may be rounded along their surface.

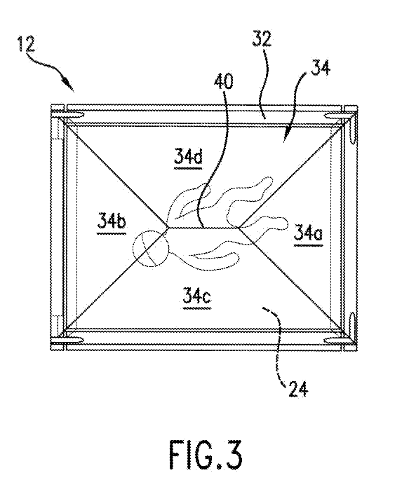

As shown in FIG. 3, the top portion 34 of the hood 12 may be further subdivided into at least four (4) pieces or facets 34a, 34b, 34c, 34d. The facets 34a-34d may be formed as separate pieces, as one unitary piece, or in any other suitable configuration. Two of the facets 34c, 34d may be substantially trapezoidal in shape and may overlie the respective left and right sides 22c, 22d of the patient support surface 22. The other two facets 34a, 34b may be substantially triangular in shape and may overlie the respective front and rear sides 22a, 22b of the patient support surface 22. In the first exemplary embodiment, the triangular surface area of facets 34a and 34b are approximately equal. Similarly, the trapezoidal surface area of facets 34c and 34d are approximately equal.

The top portion 34 of the hood 12 may contact upper ends 36 of the sidewalls 32a-32d when the top portion is in a ‘closed’ position. The closed position is shown in FIGS. 1-3. The top portion 34 of the hood 12 may be moved to an ‘open’ position where the upper ends 36 of the sidewalls 32a-32d do not contact the top portion. The open position is shown in FIG. 4 where the hood 12 is pivoted approximately 90°, with respect to the patient support surface 22. As shown in FIGS. 2A and 2B, the lower ends 38 of the sidewalk 32a-32d may contact, or be coupled to, the patient support assembly 14 or the patient support surface 22. As will be understood by those of ordinary skill in the art, the one or more sidewalls 32 may be formed as separate pieces, as a unitary member (of substantially rectangular shape), or in some other suitable shape (e.g., two cooperating L-shaped pieces, a U-shaped piece cooperating with a single sidewall, etc.).

FIG. 2A shows a front side plan view of the patient support surface 22 and hood 12 shown in FIG. 1. This figure primarily shows the front side 22a of the patient support surface 22, as well as the front side wall 32a and the front facet 34a of the hood 12. Those of ordinary skill in the art will notice that the left and right sidewalls 32c, 32d of the hood 12 may be angled toward each other at an angle A₂, with respect to the patient support surface 22. A₂ may be about 40° to about 100°. In the example shown here, A₂ is preferably about 82°. The left and right facets 34c, 34d have substantially flat surfaces with a uniform thickness (t). The left and right facets 34c, 34d are angled with respect to the substantially horizontal plane of the patient support surface 22 at an angle A₄. A₄ may be in the range of about 0° to about 45°. Preferably, A₄ is between about 18° to about 26°. More particularly, A₄ is preferably 22.67°. However, the angle of A₄ will vary with heights H₁-H₃. For example, A₄ may be about 22° when H₄ is approximately 101 mm (or 4 inches). However, for illustrative purposes, where H₄ is raised to 202 mm (or 8 inches), A₄ may be 44°.

FIG. 2B shows a right side plan view of the patient support surface 22 and hood 12 shown in FIG. 1. This figure primarily shows the right side 22d of the patient support surface 22, as well as the right side wall 32d and the right facet 34d of the hood 12. Those of ordinary skill in the art will notice that the front and rear sidewalls 32a, 32b of the hood 12 may be angled toward each other and the substantially horizontal patient support surface 22 at an angle A₁. A₁ may be in the range of about 40° to about 90°. Preferably, A₁ is about 82°. As also shown in FIG. 2B, the front and rear facets 34a, 34b of the top portion 34 of the hood 12 have substantially flat surfaces with a uniform thickness (t). The front and rear facets 34a, 34b are angled with respect to the substantially horizontal plane of the patient support surface 22 at an angle A₃. A₃ may be in the range of 0° to 45°. Preferably, A₃ is between about 18° to about 26°. More particularly, A₃ is preferably 22.67°. However, the angle of A₃ will vary with heights H₁-H₃. For example, A₃ may be about 22° when H₃ is approximately 101 mm (or 4 inches). However, where H₃ is 202 mm (or 8 inches), A₃ may be 44°.

FIGS. 2A and 2B also show that that the facets 34a-34d of the top portion 34 of the hood 12 intersect at an apex 40. FIGS. 2A and 2B also show a length L and a width W for the patient support surface 22. Length L corresponds generally to the length of the sidewall 32 and the top portion 34. Width W corresponds generally to the width of the sidewall 32 and the top portion 34. The length L may be in the range of 400-1000 millimeters (mm), and is approximately 750 mm in the exemplary embodiment. The width W may also be in the range of 400-900 millimeters (mm), and is approximately 570 mm in the exemplary embodiment. However, a patient support surface or sidewall of virtually any dimensions may be used.

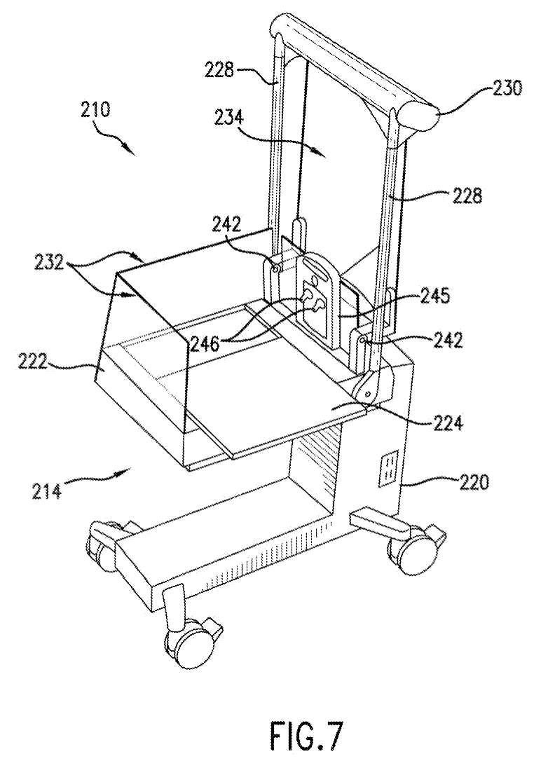

In an embodiment with multiple support arms, such as the one shown in FIG. 7, the width W of the hood and the angle between a sidewall and the patient support (i.e., A₁ and A₂), surface preferably allows the sidewall 32 to fit between the support arms when the hood is in the open position. FIG. 2A also shows a height H₁ (as measured from the bottom of the sidewall to the apex 40), a height H₂ of the sidewall 32, and a height H₃, which is the height of the top portion and the difference between H₁ and H₂. The height H₁ may be in the range of 100-500 millimeters (mm), and is approximately 356 mm (or 14 inches) in the exemplary embodiment. The height H₂ may be in the range of 100-500 millimeters, and is approximately 254 mm (or 10 inches) in the exemplary embodiment. H₃ is in the range of 50 mm to 300 mm. In the exemplary embodiment, H₃ is approximately 101 mm (or 4 inches).

As provided above, FIG. 3 shows a top plan view of the hood 12 shown in FIG. 1. FIG. 3 shows the intersection of the four facets 34a-34d of the top portion 34 of the hood 12 at the apex 40, and also shows the relative shapes of the facets.

FIG. 4 is a left side plan view of the hood 12 shown in FIG. 1 in an ‘open’ position. As noted above, the hood 12 may be adapted to open and close to provide access to the infant patient 26. FIGS. 1-3 show the hood 12 in the ‘closed’ position. In the ‘closed’ position, the infant patient 26 is surrounded on all sides by the hood 12. Thus, in the ‘closed’ position, the hood 12 creates a closed care environment which is suitable for incubation, as is known to those of ordinary skill in the art. When the hood 12 is moved to an ‘open’ position as shown in FIG. 4, the closed care environment is disrupted.

The hood 12 may include coupling means which permit the top portion 34 of the hood 12 to move away from the sidewalls 32a-32d. In the exemplar embodiment shown in FIGS. 1-4, the hood 12 includes one or more hinges 42, which allow rotation of the top portion 34 of the hood. Those of ordinary skill in the art will realize that there are various other means of attaching the top portion 34 of the hood 12. For example, the top portion 34 may be completely detachable from the sidewalls 32a-32d, or completely detachable from the patient support assembly 14 and/or patient support surface 22. As noted above, when the hood 12 is an ‘open’ position (with the top portion 34 of the hood 12 partially or completely removed), a caregiver may easily access the infant patient 26 disposed on the patient support surface 22.

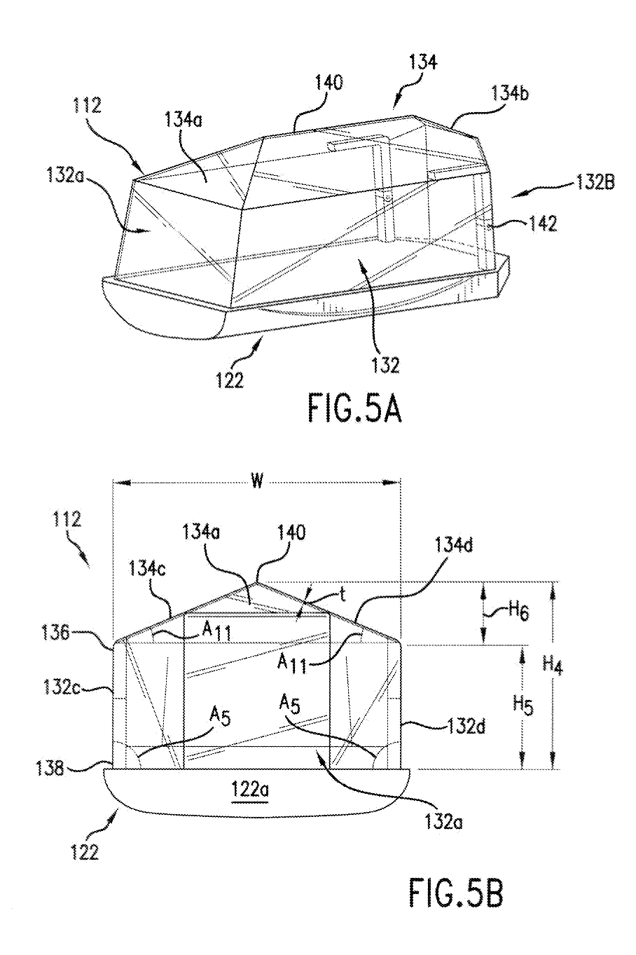

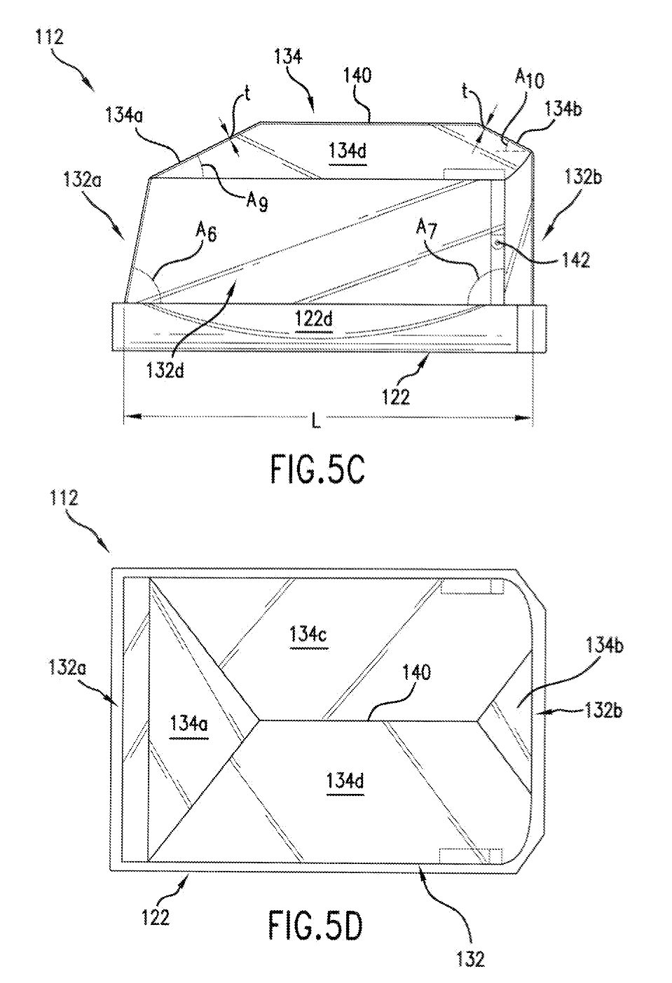

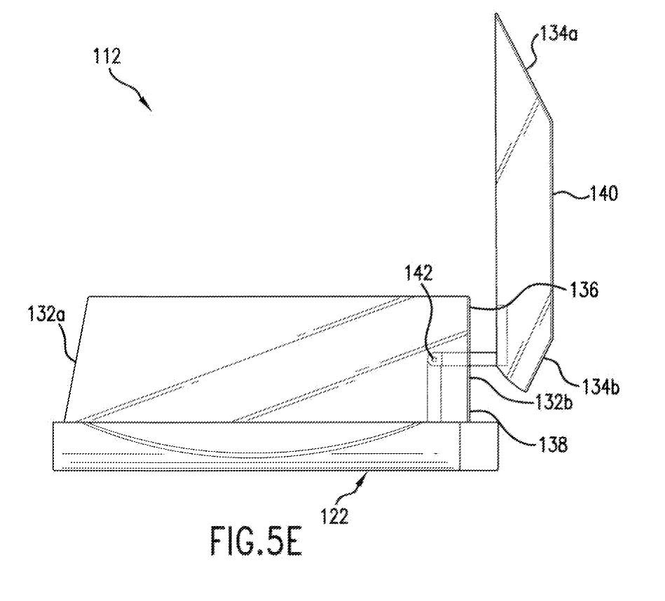

FIGS. 5A-5E show various views of a hood 112 and patient support surface 122 according to a second exemplary embodiment of the present invention. Even though a warming therapy device is not shown, hood 112 could be used with virtually any warming therapy device including the warming therapy devices shown in FIG. 1 and FIG. 7. The hood 112 and patient support surface 122 are similar to the hood 12 and patient support surface 22 of the first exemplary embodiment, and like reference numerals denote like elements.

The hood 112 may be comprised of one or more sidewalls 132, and a top portion 134. In the exemplary embodiment, the hood 112 includes four (4) sidewalls 132a, 132b, 132c, 132d, corresponding to the front, rear, right and left sides respectively. The top portion 134 and sidewalls 132a-132d of the hood 112 may be comprised of a substantially transparent material such as a clear polymer. However, those of ordinary skill in the art will understand that the top portion 134 and sidewalls 132a-132d of the hood 112 may be made of other materials as long as they allow viewing of an infant patient disposed on the patient support surface 122, and maintain the desired environmental conditions (i.e., temperature and humidity levels). Although the sidewalls 132a-132d are shown as substantially rectangular, those of ordinary skill in the art will realize that the sidewalls may be of any suitable shape, such as square, trapezoidal, rounded, etc. Additionally, although these sidewalls 132a-132d are shown as substantially flat along their surface those of ordinary skill in the art will realize that 132a-132d may be rounded along their surface.

As shown in FIG. 5D, the top portion 134 of the hood 112 may be further subdivided into at least four (4) pieces or facets 134a, 134b, 134c, 134d. The facets 134a-134d may be formed as separate pieces, as one unitary piece, or in any other suitable configuration. Two of the facets 134c, 134d may be substantially trapezoidal in shape and may have at least one rounded edge. The other two facets 134a, 134b may be substantially triangular in shape. In other embodiments, either or both of facets 134a, 134b are “pie”-shaped. (By pie-shaped it is meant that the pieces are a triangular sector or portion of a circle.) In the second exemplary embodiment, the surface area of facets 134a and 134b are not equal but the surface area of facets 134c and 134d are approximately equal. In other embodiments, the surface area of 134a and 134b may be equal.

As shown in FIG. 5B, the top portion 134 of the hood 112 may contact upper ends 136 of the sidewalls 132a-132d when the top portion is in a ‘closed’ position. However, as shown in FIG. 5E and explained below, the top portion 134 of the hood 112 may be moved to an ‘open’ position where the upper ends 136 of the sidewalls 132a-132d do not contact the top portion. The lower ends 138 of the sidewalls 132a-132d may contact, or be coupled to, the patient support surface 122, as shown in FIG. 5B. As will be understood by those of ordinary skill in the art, the one or more sidewalls 132 may be formed as separate pieces, as a unitary member (of substantially rectangular shape), or in some other suitable shape (e.g., two cooperating L-shaped pieces, a U-shaped piece cooperating with a single sidewall, etc.).

FIG. 5B shows a front side plan view of the patient support surface 122 and hood 112 shown in FIG. 5A. This figure primarily shows the front side 122a of the patient support surface 122, as well as the front side wall 132a and the front facet 134a of the hood 112. Those of ordinary skill in the art will notice that the left and right sidewalls 132c, 132d of the hood 112 are angled an angle A₅ with respect to the substantially horizontal patient support surface 122. As may be about 45° to about 110°. Preferably, A5 is about 90°.

While 90° sidewalls are shown in the exemplary embodiments, it is contemplated that a hood 112 that is wider than a patient support surface 122 may be used, resulting in angles for A₅ that are greater than 90°. Having a wider hood 112 than patient support surface 122 may help facilitate the hood capturing more airflow from an air curtain that extends upwardly from the patient support surface 122.

As also shown in FIG. 5B, the left and right facets 134c, 134d of the top portion 134 of the hood 112 have substantially flat surfaces with a uniform thickness (t). The left and right facets 134c, 134d are angled with respect to the substantially horizontal plane of the patient support surface 122 at an angle A₁₁. A₁₁ may be in the range of 0° to 65°. Preferably. A₁₁ is between about 18° to 26°. More particularly, A₁₁ is preferably 22.67°. However, the angle of A₁₁ will vary with heights H₄-H₆. For example, A₁₁ may be about 22° when H₆ is approximately 101 mm (or 4 inches). However, where H₆ is 202 mm (or 8 inches), A₁₁ may be 44°.

FIG. 5C shows a right side plan view of the patient support surface 122 and hood 112 shown in FIG. 5A. This figure primarily shows the right side 122d of the patient support surface 122, as well as the right side wall 132d and the right facet 134d of the hood 112. Those of ordinary skill in the art will notice that the front sidewall 132a of the hood 112 is angled toward the rear sidewall and the patient support surface 122 at an angle A₆. A₆ may be in the range of about 45° to about 100°, and is about 90° in the exemplary embodiment. Those of ordinary skill in the art will notice that the rear sidewall 132a of the hood 112 is angled at an angle A₇ with respect to the patient support surface 122. A₇ may be in the range of about 40° to 110° and is preferably 90° in the exemplary embodiment.

As also shown in FIG. 5C, the front facet 134a of the top portion 134 of the hood 112 has a substantially flat surface with a uniform thickness it). The front facet 134a is angled with respect to the substantially horizontal plane of the patient support surface 122 at an angle A₉. The rear facet 134b of the top portion 134 of the hood 112 also has a substantially flat surface with a uniform thickness (t). The rear facet 134b is angled with respect to the substantially horizontal plane of the patient support surface 122 (shown with an imaginary horizontal line, through 134d) at an angle A₁₀. A₉ may be in the range of 0° to 45° Preferably, A₉ is between about 18° and about 26°. More particularly, A₉ is preferably 22.67°. A₁₀ may be in the range of 0° to 45°. Preferably, A₁₀ is also between about 18° and about 26°. More particularly. A₁₀ is preferably 22.67°. However, the angles of A₉ and A₁₀ will vary with heights H₄-H₆. For example, A₉ and A₁₀ may be about 22° when H₆ is approximately 101 mm (or 4 inches). However, where H₆ is 202 mm (or 8 inches) A₃ may be 44°.

FIGS. 5A-5E also show that the facets 134a-134d of the top portion 134 of the hood 112 intersect at an apex 140. FIGS. 5B and 5C also show a length L and a width W for the hood 112. Length L corresponds generally to the length of the sidewall 132 and the top portion 134. Width W corresponds generally to the width of the sidewall 132 and the top portion 134. The length L may be in the range of 500-850 millimeters (mm), and is approximately 750 mm in the exemplary embodiment. The width W may also be in the range of 500-850 millimeters (mm), and is approximately 568 mm in the exemplary embodiment. However, a patient support surface and sidewall of virtually any dimensions may be used. In an embodiment with multiple support arms, such as the one shown in FIG. 7, the width W of the hood and the angle between a sidewall and the patient support (i.e., A₅, A₆ and A₇), surface preferably allows the sidewall 132 to fit between the support arms when the hood is in the open position.

FIG. 5B also shows a height H₄ of the hood 112 (as measured from the lower end 138 of the sidewall 132 to the apex 140), a height H₅ of the sidewall 132 and a height H₆, which is the height of the top portion 134 or the difference between H₄ and H₅. The height H₄ may be in the range of 100-500 millimeters (mm), and is approximately 356 mm (or 14 inches) in the exemplary embodiment. The height H₅ may be in the range of 100-500 millimeters, and is approximately 254 mm (or 10 inches) in the exemplary embodiment. H₆ is in the range of 50 mm to 300 mm. In the exemplary embodiment, H₆ is approximately 101 mm (or 4 inches).

As provided above, FIG. 5D shows a top plan view of the hood 112. FIG. 5D shows the intersection of the four facets 134a-134d of the top portion 134 of the hood 112 at the apex 140, and also shows the relative shapes of the facets.

FIG. 5E is a let side plan view of the hood 112 shown in FIG. 5A, where the hood 112 is in an ‘open’ position. As noted above, the hood 112 may be adapted to open and close to provide access to the infant patient (not shown), FIGS. 5A-5D show the hood 112 in the ‘closed’ position. In the ‘closed’ position, the hood patient is surrounded on all sides by the hood 112. Thus, in the ‘closed’ position, the hood 112 creates a closed care environment which is suitable for incubation, as is known to those of ordinary skill in the art. When the hood 112 is moved to an ‘open’ position as shown in FIG. 5E, the closed care environment is disrupted.

FIGS. 6A-6D and 7 show a warming therapy device 210 according to a third exemplary embodiment of the present invention. The warming therapy device 210 includes a hood 212 and patient support assembly 214. The warming therapy device 210 includes a radiant heater head 230, and a patient support surface 222. The hood 212 has a top portion 234 which may pivot about one or more hinges 242. The hood 212 may also include one or more side walls 232 which may be slideable, removable, pivotable or rotatable. The patient support surface 222 also preferably includes a mattress 224 disposed therein. The warming therapy device 210 may optionally include a backplane 245, to which ventilation hoses and other devices (not shown) may be coupled through, for example, interconnection nozzles 246.

As shown in FIG. 6B, the top portion 234 of the hood 212 may be further subdivided into at least six (6) pieces or facets 234a, 234b, 234c, 234d, 234e, 234f. The facets 234a-234f may be formed as separate pieces, as one unitary piece, or in any other suitable configuration. Facets 234a and 234b may be substantially trapezoidal, rectangular, square, etc. and may overlie the respective front and rear sides 222a, 222b of the patient support surface 222. Two of the facets 234c, 234d may be hexagonal, trapezoidal or rectangular in shape and may overlie the respective left and right sides 222c, 222d of the patient support surface 222, as shown in FIGS. 6C and 6D. The trapezoidal surface area of facets 234c and 324d are approximately equal. Facets 234a and 234b may be trapezoidal with rounded edges. The trapezoidal surface area of facets 234a and 324b are approximately equal. Facets 234e and 234f may be triangular, or pie-shaped; i.e., may be a circular segment. The triangular surface area of facets 234e and 234f are approximately equal.

As shown in FIGS. 6C and 6D, the bottom portion of the hood 238 contacts and may be coupled to the patient support surface 222. The top portion 234 of the hood 212 may contact upper ends 236 of the sidewalls 232a-232d when the top portion is in a ‘closed’ position, which is shown in FIGS. 6A-6D. The top portion 234 of the hood 212 may be moved to an ‘open’ position where the upper ends 236 of the sidewalls 232a-232d do not contact the top portion, as shown in FIG. 7 and described below.

FIG. 7 shows the top portion 234 of the hood 212 rotated up so that it is approximately ninety degrees (90°) with respect to the support surface 222. The width W of the hood and the angle between a sidewall and the patient support (i.e., A₁₂ and A₁₄), surface preferably allows the sidewall 232 to fit between the support arms when the hood is in the open position. In the exemplary embodiment shown in FIG. 7, the side walls 232 of the hood 212 are capable of sliding vertically within a portion of the support surface 222, so that they may become disposed, partially or completely, below the plane of the support surface 222. Also, the mattress 224 is rotated and slid from the support surface. It is noted that the sidewalls 32, 132 of hoods 12, 112, may also be capable of sliding vertically within a portion of the support surface 22, 122, so that they may become disposed, partially or completely, below the plane of the support surface 22, 122. In addition, hoods 12, 112 may comprise a mattress that may be rotatable and slidable. As will be understood by those of ordinary skill in the art, the one or more sidewalls 232 may be formed as separate pieces, as a unitary member (of substantially rectangular shape), or in some other suitable shape (e.g., two cooperating L-shaped pieces, a U-shaped piece cooperating with a single sidewall, etc.).

FIG. 6C shows a front side plan view of the hood 212 shown in FIG. 6A. This figure primarily shows the front side 222a of the patient support surface 222, as well as the front side wall 232a, front 234a and facet 234e. Those of ordinary skill in the art will notice that the left and right sidewalls 232c, 232d of the hood 212 are angled at an angle A₁₂ with respect to the patient support surface 222. A₁₂ may be about 40° to about 90° A₁₂ is preferably about 90°. As also shown in FIG. 6C, the left facet 234c and the right facet 234d have substantially flat surfaces with a uniform thickness (t). In addition, the left and right facets 234c, 234d are angled with respect to the substantially horizontal plane of the patient support surface 22 at an angle A₁₆. A₁₆ may be in the range of 0° to 45°. Preferably, A₁₆ is between about 18° to about 26°. More particularly, A₁₆ is preferably 22.67°. However, the angle of A₁₆ will vary with heights H₇-H₉. For example, A₁₆ may be about 22° when H₉ is approximately 101 mm (or 4 inches). However, where H₉ is 202 mm (or 8 inches), A₁₆ may be 44°.

FIG. 6D shows a right side plan view of the patient support surface 222 and hood 212 shown in FIG. 6A. This figure primarily shows the right side 222d of the patient support surface 222, as well as the right side wall 232d and the right facet 234d of the hood 212. Those of ordinary skill in the art will notice that the front and rear sidewalls 232a, 232b are angled at an angle A₁₄ with respect to the patient support surface 222. A₁₄ may be about 40° to about 90°. A₁₄ is preferably 90°. As also shown in FIG. 6D, facet 234e and facet 234f have substantially flat surfaces with a uniform thickness (t). Facets 234e, 234f are angled with respect to the substantially horizontal plane of the patient support surface 222 (shown as an imaginary horizontal plane along facet 234d) at an angle A₁₈. A₁₈ may be in the range of 0° to 45°. Preferably, A₁₈ is between about 18° to 26°. More particularly, A₁₈ is preferably 22.67°. However, the angle of A₁₈ will vary with heights H₇-H₉. For example, A₁₈ may be about 22° when H₉ is approximately 101 mm (or 4 inches). However, where H₉ is 202 mm (or 8 inches), A₁₈ may be 44°.

FIGS. 6C and 6D also show that the facets 234a-234f of the top portion 234 of the hood 212 intersect at an apex 240. FIG. 6C shows a width (W) of the patient support surface 222, which corresponds generally to the width of the sidewall 232 and top portion 234. The width W may be in the range of 500-850 millimeters (mm), and is approximately 568 mm in the exemplary embodiment. FIG. 6D shows a length (L) of the patient support surface 222, which corresponds generally to the length of the sidewall 232 and top portion 234. Length (L) may be in the range of 500-850 millimeters (mm), and is approximately 750 mm in the exemplary embodiment. However, a patient support surface and sidewall of virtually any dimensions may be used.

FIG. 6C also shows a height H₇ of the hood 212 (as measured from the lower end 238 of the sidewall 232 to the apex 240), a height H₈ of the sidewall 232, and a height H₉, which is the height of the top portion 234 or the difference between H₇ and H₈. The height H₇ may be in the range of 100-500 millimeters (mm), and is approximately 356 mm (or 14 inches) in the exemplary embodiment. The height H₈ may be in the range of 100-500 millimeters, and is approximately 254 mm (or 10 inches) in the exemplary embodiment. H₉ is in the range of 50 mm to 300 mm. In the exemplary embodiment, H₉ is approximately 101 mm (or 4 inches).

All of the above-described exemplary embodiments of the hood (12, 112, 212) provide distinct advantages. The faceted design of the top portion (34, 134, 234) allows a caregiver to view an infant patient from virtually any viewing angle. As opposed to hoods with rounded edges, the hoods of the exemplary embodiments of the present invention permit the caregiver to see directly into the hood, without distortion, and without significant retraction and/or reflection of light. The same applies to diagnostic images such as x-rays, radiography, etc., of the infant patient. The flat surfaces of the facets, their thickness (t) and their angle with respect to the patient support surface, provides for more accurate diagnostic images. In addition, the height of facets (as measured from the floor on which a warming therapy device sits), their angles, thickness (t), and their substantially flat surfaces provide the average caretaker with an optimal sightline through the particular facet that the caretaker is looking through to see the patient. In addition, the height of the warming therapy devices (10, 110, 210) according to the exemplar embodiments of the present invention may be adjustable for short or taller caretakers.

Further, where a heater forms part of the warming therapy device (e.g. radiant heater head 230), the various exemplary embodiments of the hood allow better control of desired heat and humidity levels within the closed care environment created by the hood. In particular, with the various embodiments of the hood, the heater provides heat through the flat plane of one of the facets that has a uniform thickness (t). The flat surface area of the facet with a uniform thickness allows more uniform heating over the surface area of the facet, which provides more uniform heating within the closed care environment. This allows for improved heat and humidity control and less condensation on the hood. Some conventional hoods, the thickness of the rounded surfaces is often variable making for unequal heating of the hood also making controlling the environmental conditions within the hood more difficult.

Also, some conventional hoods with rounded edges (and otherwise) have dimensions larger than necessary to maintain the desired closed care environment. The exemplary embodiments provide the optimal hood dimensions, which amounts to a reduction in volume over the conventional hoods. The reduction in the overall volume of the interior of the hood allows for a reduction in energy consumption required to maintain the temperature within the hood. For example, many warming therapy devices seek to maintain a temperature of ninety degrees Fahrenheit (90° F.) or above inside the hood, and when the volume of the hood is decreased as described above less energy is required to maintain such a constant temperature, resulting in increased energy efficiency.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein. An apparatus as described above with reference to the foregoing description and appended drawings is hereby claimed.

What is claimed is:

1. An apparatus comprising:
a patient support surface; and
a hood adapted to cover a portion of the patient support surface, wherein the hood is comprised of at least one sidewall and at least one top portion and wherein the at least one top portion is faceted.

2. The apparatus of claim 1, wherein the at least one sidewall comprises at least four sidewalls.

3. The apparatus of claim 1, wherein the at least one top portion is comprises at least four facets.

4. The apparatus of claim 3, wherein at least two of the at least four facets are angled with respect to the patient support surface in a range from 0 to 45 degrees.

5. The apparatus of claim 4, wherein at least two of the at least four facets are angled with respect to the patient support surface at an angle of approximately 22-23 degrees.

6. The apparatus of claim 3, wherein at least two of the at least four facets are angled with respect to the patient support surface in a range from 40 to 100 degrees.

7. The apparatus of claim 6, wherein all four facets are angled with respect to the patient support surface at an angle of approximately 22-23 degrees.

8. The apparatus of claim 1, wherein at least two of the at least four facets are substantially trapezoidal.

9. The apparatus of claim 1, wherein at least two of the at least four facets are substantially triangular.

10. The apparatus of claim 1, wherein the top portion is rotatable with respect to the at least one sidewall.

11. A hood for a warming therapy device adapted to cover a portion of a patient support surface, the hood comprising:
at least one sidewall; and
at least one top portion,
wherein the at least one top portion comprising a plurality of facets.

12. The hood of claim 11, wherein the at least one sidewall comprises at least four sidewalls.

13. The hood of claim 11, wherein the at least one top portion comprises at least four facets.

14. The hood of claim 13, wherein at least two of the at least tour facets are angled with respect to the patient support surface in a range from 0 to 45 degrees.

15. The hood of claim 14, wherein at least two of the at least four facets are angled with respect to the patient support surface at an angle of approximately 22-23 degrees.

16. The hood of claim 13, wherein at least two of the at least four facets are angled with respect to the patient support surface in a range from 40 to 90 degrees.

17. The hood of claim 16, wherein all four facets are angled with respect to the patient support surface at an angle of approximately 22-23 degrees.

18. The hood of claim 11, wherein at least two of the at least four facets are substantially trapezoidal.

19. The hood of claim 11, wherein at least two of the at least four facets are substantially triangular.

20. The hood of claim 11, wherein the top portion is rotatable with respect to the at least one sidewall.

21. A warming therapy device comprising:
a patient support assembly having a patient support surface; and
a hood coupled to the patient support assembly, the hood adapted to cover a portion of the patient support surface,
wherein the hood is comprised of at least one sidewall and at least one top portion, and wherein the at least one top portion comprises a plurality of facets.

22. The warming therapy device of claim 21, wherein the at least one sidewall comprises at least four sidewalls.

23. The warming therapy device of claim 21, wherein the at least one top portion is comprised of at least four facets.

24. The warming therapy device of claim 21, wherein at least two of the at least four facets are substantially trapezoidal.

25. The warming therapy device of claim 21, wherein at least two of the at least four facets are substantially triangular.

26. The warming therapy device of claim 21, wherein at least one portion of the sidewall has a height greater than the remainder of the sidewall.

27. The warming therapy device of claim 21, wherein the facets have substantially flat surfaces.

28. The warming therapy device of claim 23, wherein the at least four facets are disposed at an angle of about 22-23 degrees with respect to the patient support surface.

29. The warming therapy device of claim 23, wherein at least two of the at least four facets meet at an apex.

30. The warming therapy device of claim 23, wherein the top portion is comprised of at least six facets.

31. The warming therapy device of claim 25, wherein at least one of the at least two substantially triangular facets is pie-shaped.

32. The warming therapy device of claim 25, wherein one of the at least two substantially triangular facets has a surface area larger than the surface area of the other of the at least two substantially triangular facets.

33. The warming therapy device of claim 25 wherein one of the at least two substantially triangular facets is disposed adjacent a front portion of the warming therapy device and another of the at least two substantially triangular facets is disposed adjacent a rear portion of the warming therapy device.

34. The warming therapy device of claim 21, wherein the top portion is rotatable with respect to the at least one sidewall.
